(19) United States
(12) Patent Application Publication
(10) Pub. No.: US 2021/0367933 A1
(43) Pub. Date: Nov. 25, 2021

(54) METHOD AND SYSTEM TO ENSURE THAT ALL PARTICIPANTS IN THE GENERATION OF A PROTECTED DATA SET OR DATA STREAM THROUGH ENCRYPTION ARE REQUIRED TO PROVIDE THEIR PERMISSION FOR THE DATA TO BE RETRIEVED THROUGH DECRYPTION

(71) Applicant: Richard Edward Rejmaniak, Pennsburg, PA (US)

(72) Inventor: Richard Edward Rejmaniak, Pennsburg, PA (US)

(21) Appl. No.: 16/878,408

(22) Filed: May 19, 2020

(51) Int. Cl. H04L 29/06; G07C 9/00; H04L 9/08

(52) U.S. Cl. CPC H04L 63/0478; H04L 63/065; H04L 9/0825; G07C 9/00309; H04L 9/0822; H04L 63/105

(57) ABSTRACT

The present invention comprises a system that will ensure the privacy of multiple participants being recorded during an activity that is considered to be confidential due to legal, professional, and/or other concerns. Video, audio, telemetry, and other information is encrypted using identifying credentials, such as identifying physical devices, knowledge of specific codes or information, and/or biologically originated identifiers, from all parties in a manner such that all, or a pre-determined specific subset, of the parties must provide the original credentials in order to decrypt the encrypted information. This system assures that no individual can access the encrypted information without the active participation of the required other members who provided encryption credentials.

### CROSS-REFERENCES

Provisional Application No. 62/750,186, filed on Oct. 24, 2018

### BACKGROUND OF THE INVENTION

Medical practitioners are, by nature of their profession, often involved with intimate physical and/or deep psychological involvement with their patents. In many cases the patient may be under anesthesia and is technically vulnerable to unwanted contact. Even procedures typically not considered to be intimately invasive, such as dental work, can result in anesthesia being administered to a patient. Anesthesia can also result in false memories and a tenuous grasp of actual events. In the case of psychological sessions, patients, due to their condition, can conclude that events that did not transpire have actually happened. There is a growing need to be able to determine exactly what transpired between a practitioner and patient.

A common solution is to have a chaperone present during examinations; however, this is an imperfect solution. A chaperone is normally employed by the practitioner, and thus can have their testimony questioned or dismissed as being biased. Having a second person present can also be expensive and difficult to schedule. In the cases where the patient is under anesthesia, the fact that the chaperone was there the entire time and not distracted cannot be proven. For highly intimate examinations, such as gynecological and obstetric examinations and procedures, the chaperone will almost certainly not be in a position to peer over a doctor's shoulder and observe the actual doctor/patient physical contact, and it would most likely not be acceptable to the patient if such observations were attempted. In the case of psychological counselling, a second person in the room can make the patient hesitant to communicate and thus interfere with the treatment.

A reliable solution would be to have a video and audio recording of the appointment or procedure. However patient privacy concerns would normally make this unworkable. The patient would typically be uncomfortable with an intimate recoding of their examination being in the hands of a doctor's IT staff, which may not have the competency or strength of character to be trusted. Doctor's also face damning consequences if the security of any of the recordings of a patient were to be compromised.

While the scenarios presented so far are related to medical practitioners, other personal exchanges, such as between employer representatives and employees, lawyers and clients, and private contractual negotiations, to name a few, are situations where proof of what transpired can be needed to preclude any coercion, dishonesty, or disreputable behavior. All these situations are extremely sensitive and can have legal and criminal ramifications should accidental or intentional disclosure of the records of the session occur without the consent of all parties involved.

Therefore, a need exists to be able to reliably provide an exact, detailed, and trusted record of what transpired during an interaction between a doctor and patient, as well as the participants of the different scenarios listed above. This record must be secure to the point where it is not physically possible for it to be disclosed without the active participation of any and all parties involved, even if the physical data record should end up in possession of an unauthorized agent.

### FIELD OF THE INVENTION

This invention relates to a method and system for ensuring that all participants allow the revelation through decryption of a data stream or data set in which all of the participants agreed on its protection through encryption. More particularly, this invention provides a means for confidential video, audio, and data recordings of medical, dental, psychological, legal, contract, personnel, and other professional and personal encounters to be rendered unreadable through encryption by all parties, such as a doctor, patient, and third parties such that no single party can access the data without the active participation of all of the original participants granting permission.

### BRIEF SUMMARY OF THE INVENTION

The method and the system of this invention is centered around the innovative concept of providing the means to have a digital record of confidential interactions that is protected by encryption in real-time by private credentials that are provided by both, and authorized subset of, or all parties. Retrieval of the data through decryption by any single party without the active participation of the other party or parties would not be possible. Such protected recordings would also not be able to be revealed through decryption by any third parties that obtained a copy of the recorded data.

### BRIEF DESCRIPTION OF THE DRAWINGS

A clear understanding of the key features of the invention summarized above may be had by reference to the appended drawings, which illustrate the method and system of the invention, although it will be understood that such drawings depict preferred embodiments of the invention and, therefore, are not to be considered as limiting its scope with regard to other embodiments which the invention is capable of contemplating. Accordingly:

FIG. 1 is an illustration of the method and system of this invention showing a simplified list of possible inputs that identify a participant and result in the information that contributes to the construction of the participants component of the final protection encryption key.

FIG. 2 is an illustration of the method and system of this invention showing the conceptualization of how information from different sources can be combined to generate a unique mathematical signature identifying each participant that contributes to the final protection encryption key.

FIG. 3 is an illustration of the method and system of this invention showing that the final protection encryption key is comprised of the mathematical combination of the unique identifiers from all participants.

FIG. 4 is a diagram illustrating a potential list of different types of data streams and sets, generated by data recording and/or data producing systems, that will be protected by the generated encryption key.

FIG. 5 shows the steps used by this system and method to accomplish the protection of the data stream and/or set through encryption using the combined credentials of the participants.

FIG. 6 shows the steps used by this system and method to accomplish the retrieval through decryption of the protected data stream using the same combined credentials of the participants that was used to originally protect the data.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise.

It will be further understood that the terms “comprise” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having an ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims. While the present invention has been described in terms of particular embodiments and applications, in both summarized and detailed forms, it is not intended that these descriptions in any way limit its scope to any such embodiments and applications, and it will be understood that many substitutions, changes and variations in the described embodiments, applications and details of the method and system illustrated herein and of their operation can be made by those skilled in the art without departing from the spirit of this invention.

The terms “data” and “information” are used herein, and their meaning outside of this patent can often result in them being used interchangeably and/or as synonyms. In this patent the meaning of these terms will be separated to indicate different aspects of their definitions. The terms “data”, “data stream”, and “data set”, are defined in this patent to refer to binary patterns collected during the session involving the participants that is to be protected by the methods and systems of this invention. The term “information” is defined as referring to characteristics of the participants that can be represented in, and/or distilled down to, binary patterns that can be interjected into the mathematic and/or cryptographic algorithms, processes, equations, etc. to be used as a key for the encryption and decryption steps that are used to implement the protection and retrieval of the data stream and/or data set. Put simply, “information” is obtained from the participants to allow the methods and systems defined in this patent to protect and retrieve “data” from the session involving the participants.

The term “data steam” is further defined to indicate data that is in the process of flowing through or being transported by the methods and systems described in this invention. While flowing through or being transported by this invention, the data in the data stream may be stored and/or cached as a step in the transport of said data.

The term “data set” is further defined to indicate data that is primarily contained in storage. Such data sets can be used as the input or output of the methods and systems described in this invention.

The term “data”, when used alone, can refer to either or both data streams and/or data sets.

The term “encryption” is used herein, and is understood to mean any mathematic, cryptographic, computational, or other means to render a data stream and/or data set in any form to be unintelligible after the afore mentioned means has acted upon the data. This applies to all means currently known and means in the future that will supersede current means.

The term “decryption” is used herein, and is understood to mean any mathematic, cryptographic, computational, or other means to recover information in any form that was made to be to be unintelligible by the means described in the above paragraph. This applies to all means currently known and means in the future that will supersede current means.

It should be noted that the examples in this patent application imply the use of symmetric encryption and decryption for simplicity and clarity when describing the overall operation of this invention. Symmetric encryption and decryption are well known methods that use the same key for encryption as is used for decryption. This invention can use these methods, but it can also use asymmetric encryption and decryption that uses mathematically related but different keys for the encryption and decryption processes. All such encryption/decryption methods, as well as any others known and/or unknown are understood to be covered by this invention.

The terms “protect/protected/protection” are used herein, and is understood to mean data that is encrypted using the method and system described in this patent such that the required participation of multiple parties is necessary, which transcends the mere encryption of the information by commonly understood means.

The terms “retrieve/retrieved/retrieval” are used herein, and is understood to mean data that is decrypted using the method and system described in this patent such that the required participation of multiple parties is necessary, which transcends the mere decryption of the data by commonly understood means.

The term “participant” is used herein, and is understood to mean an individual that contributes to the protection and retrieval of data that is intended to be protected by the methods and systems embodied in this patent by providing information that is unique to that individual. Such information can be embodied in knowledge held by the individual, biological details of the individual, and/or physical devices in possession of, or provided by, the individual.

The term “credentials” is used herein, and is understood to mean the resulting amalgamation of uniquely identifying information from a participant that, when taken as a whole, can be used in the mathematic, cryptographic, and/or computational process that results in the protection and/or retrieval of the data stream.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

A new method and system to ensure that all participants in the generation of a protected data set or data stream through encryption are required to provide their permission for the data to be retrieved through decryption is discussed herein. In the following description, for purposes of explanation, numerous specific details are set forth to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

The present invention will now be described by referencing the appended figures representing preferred embodiments.

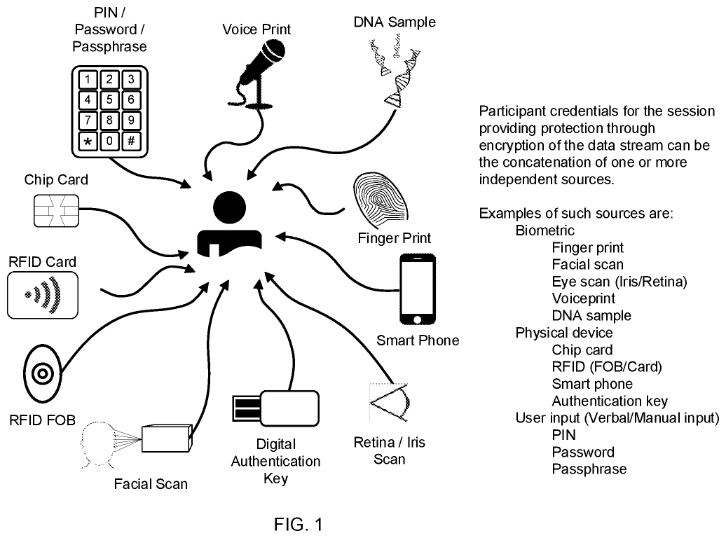

FIG. 1 provides examples of the different means by which a participant can contribute information used to protect, and then retrieve, a data stream and/or data set. Such means of personal identification shown in the figure are: An alphanumeric device, such as a keyboard or number pad (as shown) to enter a PIN, password, and/or passphrase. A chip card, an RFID fob (or card), an authentication key, such as a U2F device, are all physical devices which will exchange mathematical information contributing to a unique number. Such physical authentication devices can be based on an industry standard and allow the purchase and usage of third-party devices, and/or custom/proprietary designs that are intended for use with this invention. A smart phone that can contain a cryptographic application that will provide a unique identifier. Biometric inputs such as fingerprints, facial scans, retina scans, iris scans, voice prints, DNA signatures, etc.

Some of these methods produce the information that will contribute to the creation of the encryption key “in the clear” or “open”, meaning that the information contributed is not encrypted or hidden prior to its use. Examples would be a PIN, password, and biometric information. Other information used to create the key can be hidden behind a device where it is impossible to obtain the actual numeric source, such as a chip card, RFID device, etc. In this case a numeric challenge is provided to the device and the device produces a value that results from the mathematical combination of the challenge and the hidden value within the device. The numerical challenge is stored with the encrypted data stream and is presented to the device at the time of decryption to obtain the value that contributes to the decryption key. This invention includes all methods of providing a value to contribute to the generation of the encryption/decryption key, including methods that have the value in the “open” as well as hidden values.

This list is representative and not exhaustive. It is understood that other methods of allowing participants to uniquely identify themselves using known, unknown, and yet to be discovered and/or invented methods, processes, procedures, and/or objects are within the scope of this invention.

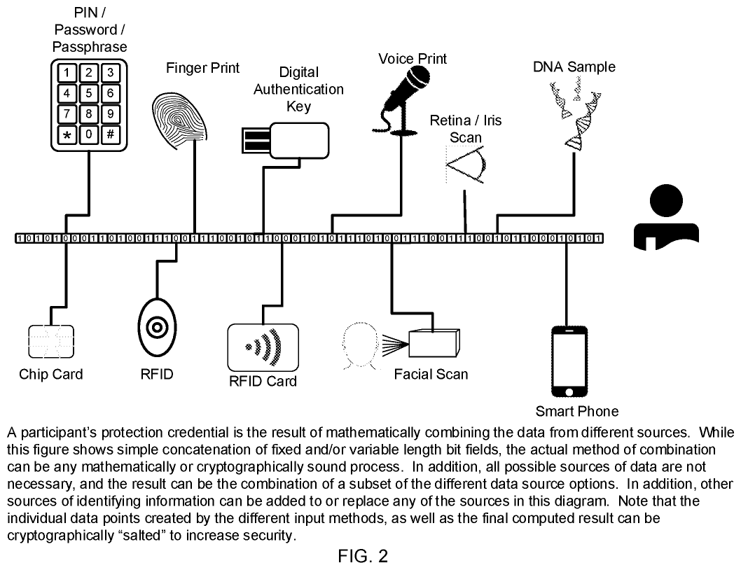

FIG. 2 illustrates that the credentials for a participant can be comprised of multiple sources of information about the individual. Some illustrative examples are a system that implements the requirement for each participant to provide a fingerprint, a numeric PIN, and chip card for both protection and retrieval of data. Another possible configuration would be that each participant would provide a fingerprint, a face scan, a numeric PIN, a chip card, and an RFID fob. For retrieval in this scenario each participant must provide three distinct classes of information, with one class being either a finger print or face scan, the second being the numeric PIN, and the third being either the chip card or the RFID fob. These different combinations of protection and retrieval are examples and any such variations of options are covered by this invention.

In addition to the different potential contributions shown in FIG. 2, any other known, unknown, and/or future characteristics that can uniquely identify an individual can be used by the methods and systems of this invention without being considered to be outside of the scope of this invention.

The initial background section of this patent put forth scenarios that involved two participants, namely a doctor and a patient. However, it is understood that this method and system can be implemented to involve any arbitrary number of participants. In addition, the particular collection of participants can be grouped into sets such that complex combinations of participants can protect and/or retrieve the information. An example of such complex combination would be if four participants, named A, B, C, & D contributed to the protection of the information, then a system could be implemented such that data could be retrieved by the actions of participant A and participant B as well as either participant C or participant D. A more illustrative example would be the protection of a patient examination that is protected using the credentials of a doctor, a nurse, and the patient. A potential implementation of the methods and systems in this invention could allow the protected information to be retrieved by the doctor and the patient, or the nurse and the patient, but not the doctor and the nurse without the patient.

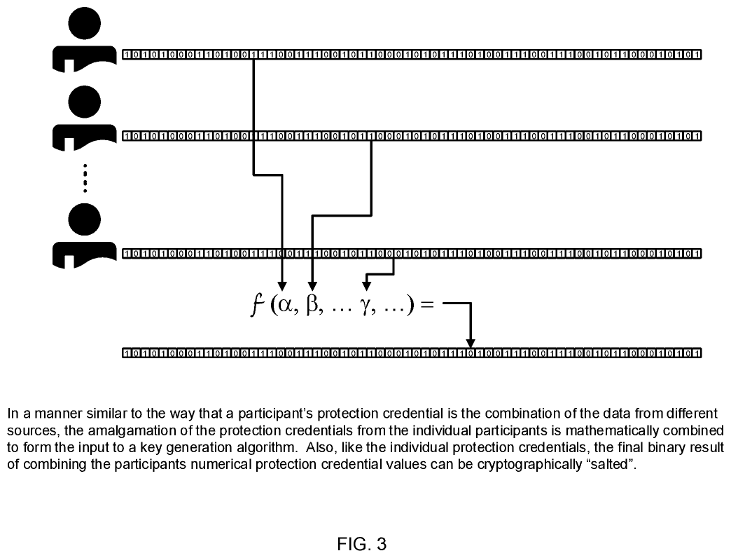

FIG. 3 illustrates how the credentials of the individual participants can be combined using mathematic, cryptographic, and/or computational methods to generate a single unified block of information for use in the protection process. In scenarios where flexible combinations of individual participant credentials and/or a flexible number of participants are intended, protection of the data can be accomplished using well understood multi-key encryption/decryption methods, and/or protection through encryption of a number of differently encrypted data streams and/or data sets reflecting the multiple intended retrieval/decryption combinations.

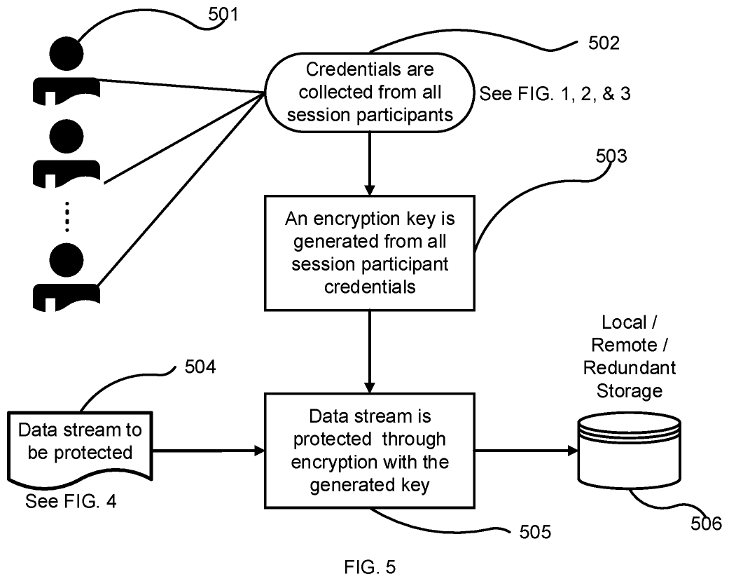

As mentioned in the text in FIG. 2 and FIG. 3, the well understood method of using cryptographic “salt values” can be used to increase the effectiveness of the encryption, and thus the protection, of the data. This step of “salting” information from participants can occur at the stage where each distinct type of information is collected from each participant, the stage where the individual participants characteristics are combined into that individual's credentials, and/or after the combining of all of the participant's credentials and prior to the submission of the aggregate credentials to the encryption key generation step indicated in FIG. 5. The option to use or not use cryptographic “salting” is an example of cryptographic steps, methods, and procedures commonly used in mathematical, cryptographic, and computational processes, and such use, as well as other variations of such protection methods, are included in the scope of this invention.

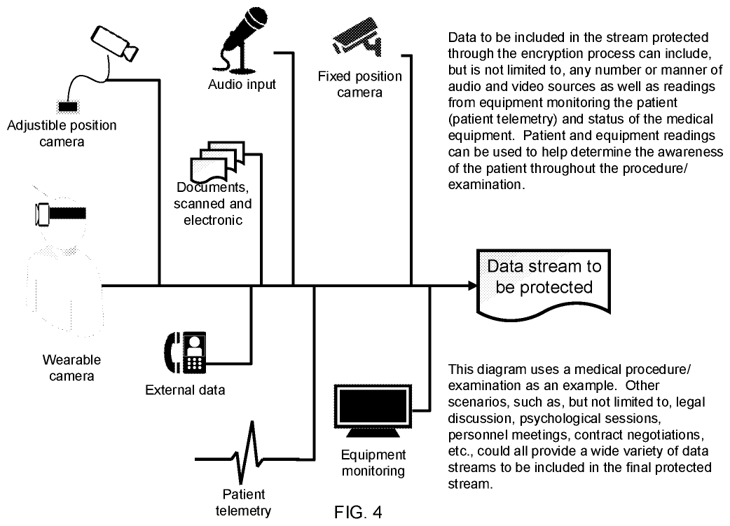

FIG. 4 provides examples of the different data sources that can be combined and protected in a single stream. These examples of data sources are not exhaustive, nor do implementations of this invention require all, or any, for that matter, of the examples herein. Other data sources, known, unknown, and yet to be discovered and/or invented can be included in the protected stream.

In the examples shown in FIG. 4, video could be provided from any number of fixed cameras located in positions around the room or location of the session. Any number of moveable cameras, such as on moveable extension arms, gooseneck arms, etc., can be positioned and placed such that specific views and angles can be added to the views in the protected data, or used in place of other cameras. Wearable cameras can be affixed to any number of participants in any manner available, including, but not limited to, head mounted, wrist mounted, eye frame mounted (both on existing eyeglasses as well as eye frames specifically intended to contain cameras), etc.

FIG. 4 also shows the inclusion of an audio source which can be any number of microphones, fixed, moveable, wearable by any participants, etc.

In addition to the likely inclusion of audio and video in the protected data, additional data sources can be included. Included patient monitoring results can be protected, such as, but not limited to, respiration, EKG, EEG, blood pressure, blood oxygen, etc. In addition, data about the state of medical equipment, including, but not limited to, systems such as anesthesia dispensing, oxygen supply, etc. can be added to the protected stream. Such information can be used to assess the lucidity of the patient should testimony be offered concerning a particular time during the session.

Data sources that are not medically specific, such as, but not limited to remote data sources, teleconferencing, document scans, computer displays, etc., can add depth to any examination of the state of the session and the behavior of the participants.

FIG. 5 shows the process of using the credentials from the participants 501 to protect the final data stream. The combined participant credentials 502 are submitted to an algorithm, mathematical process, cryptographical process, hashing process, or computation to generate a key value 503. The key value resulting from step 503 is combined using an encryption algorithm, mathematical process, cryptographical process, or computation 505 with the data stream 504 to be protected. The resulting protected data is then stored 505 on a system that is local, remote, and/or both to become a protected data set.

The protected data set 506 can reside locally, remotely, or both. It can also be stored locally until it is transferred to a remote location or locations.

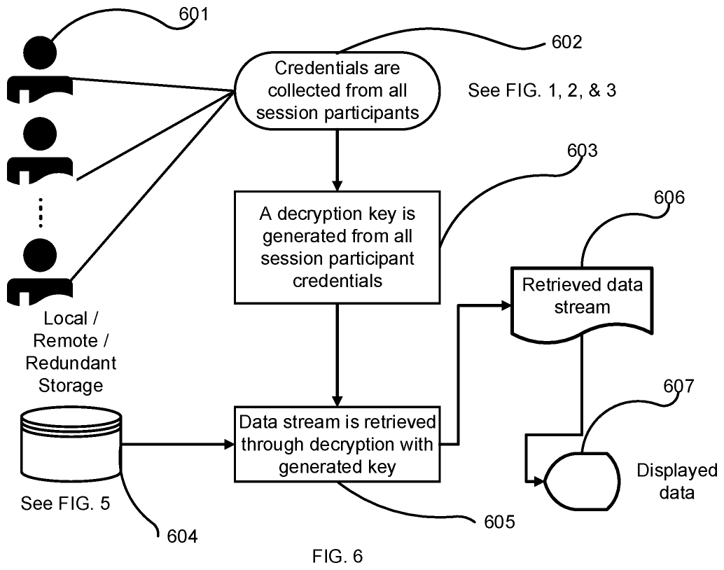

FIG. 6 illustrates the process of this invention that uses the credentials from the participants 601 to retrieve the protected data and makes it visible to the those authorized by the participants. The combined participant credentials 602 are submitted to an algorithm, mathematical process, cryptographical process, hashing process, or computation to generate a key value 603. The key value resulting from step 603 is combined using a decryption algorithm, mathematical process, cryptographical process, or computation 605 with the protected data set 604 to be retrieved. The resulting retrieved data stream 606 can them be displayed or otherwise made available in human intelligible form or to devices and/or systems that can process the data into a form relevant to the observation of the protected session.

1. A method of protecting confidential or sensitive information such that no party external to the creation of said information, nor single party participating in the creation of said information, or unauthorized subset of parties participating in the creation of the said information, can access the information without the participation of all of the other parties, or an authorized subset of the other parties, comprising; collection of one or more uniquely identifying pieces of information from each party; the combining and processing of all collected identifying information into a single encryption key or set of encryption keys; the creation of an encrypted representation or multiple encryption representations of said information.

2. The method of claim 1 wherein the information is of the nature that must be held in confidence due to requirements of law, professional standards, patient/client confidentiality, corporate security, and/or privacy concerns.

3. The method of claim 1 wherein the information is of the nature to protect one or more of the participants from false accusations, claims, etc. of impropriety, unprofessional behavior, illegal activity, etc., or to support accurate accusations, claims, etc. of impropriety, unprofessional behavior, illegal activity, etc.

4. The method of claim 1 wherein the information itself is desired to be held in confidence as opposed to the information's being used to provide physical access to a secure facility, location, and/or materials, such as the authorization to unlock secure storage, to activate the operation of system or device, or to provide the ability to enter a physical location.
